(19) United States
(12) Patent Application Publication
(10) Pub. No.: US 2021/0296711 A1
(43) Pub. Date: Sep. 23, 2021

(54) SOLAR RECHARGEABLE VEHICLE REFRIGERATOR WITH PLUG-IN BATTERY

(71) Applicant: FOSHAN ALPICOOL ELECTRIC APPLIANCE CO., LTD., Foshan (CN)

(72) Inventors: PIZHI ZHAO, Qingyuan (CN); Kunyong Huang, Guigang (CN); Tao Zeng, Foshan (CN); Junjie Qin, Nanning (CN); Shaohui Chen, Yichun (CN)

(21) Appl. No.: 16/899,537

(22) Filed: Jun. 11, 2020

(30) Foreign Application Priority Data
Mar. 20, 2020 (CN) 202020363558.7
Mar. 20, 2020 (CN) 202020364395.4

(51) Int. Cl. H01M 10/46; H01M 10/42; H01M 10/48; F25D 11/00; F25D 29/00; H02J 7/35; H02J 7/00

(52) U.S. Cl. CPC H01M 10/465; H01M 10/425; H01M 10/488; H01M 10/486; F25D 11/003; F25D 2700/12; H02J 7/35; H02J 7/0045; H01M 2220/30; H01M 2010/4271; F25D 29/003

(57) ABSTRACT

A solar rechargeable vehicle refrigerator with plug-in battery, comprising a refrigerator body (1), wherein one side of the refrigerator body (1) is provided with a battery compartment (7) and a battery pack (2) is inserted into the battery compartment (7); the front end of the battery pack (2) is centrally and symmetrically provided with a pair of unlocking buttons (3) which can relatively and transversely move, and a spring (4) is connected between two unlocking buttons (3) which are correspondingly connected with side lock rods (5), the outer ends (51) of the side lock rods (5) are inserted into the lock holes (71) on sides of the battery compartment (7). The invention has simple structure, and the battery pack can be easily taken out and fixed in place.

### CROSS REFERENCE OF RELATED APPLICATIONS

This application claims the benefit of Chinese Patent Application No. 202020363558.7 filed on Mar. 20, 2020 and Chinese Patent Application No. 202020364395.4 filed on Mar. 20, 2020, the contents of which are incorporated herein by reference.

### TECHNICAL FIELD

The invention relates to the field of vehicle refrigerator, in particular to a solar rechargeable vehicle refrigerator with plug-in battery.

### BACKGROUND

The vehicle refrigerator is more and more loved by many car owners at present. Power supply is required in the using process of the vehicle refrigerator. Now, various power supply modes are provided, including vehicle power supply, battery packs or external vehicle solar panels. However, the current problems are that the vehicle solar energy cannot supply power to the battery pack, and the battery pack assembly and disassembly are troublesome, and cannot be taken out for charging.

### SUMMARY OF THE INVENTION

To solve the technical problems, the invention provides a solar rechargeable vehicle refrigerator with plug-in battery, which has a simple structure. The battery pack can be easily taken out and fixed in place.

The technical scheme of the invention employed to solve the technical problems of the prior art is as follows:

a solar rechargeable vehicle refrigerator with plug-in battery, comprising a refrigerator body, wherein one side of the refrigerator body is provided with a battery compartment and a battery pack is inserted into the battery compartment; the front end of the battery pack is centrally and symmetrically provided with a pair of unlocking buttons which can relatively and transversely move, and a spring is connected between two unlocking buttons which are correspondingly connected with side lock rods; the outer ends of the side lock rods are inserted into the lock holes on sides of the battery compartment; when the two unlocking buttons are pressed to move towards each other and respectively drive the corresponding side lock rods to move inwards, the outer ends of the side lock rods are separated from the lock holes of the battery compartment.

Preferably, the front end of the battery pack is provided with a front cover which can package the unlocking buttons, spring and side lock rods on the front end thereof; through grooves through which the ends of the unlocking buttons can penetrate are arranged on the front cover.

Preferably, the sides of the front end of the battery pack are also provided with holes corresponding to the outer ends of the side lock rods; the outer ends of the side lock rods are inserted into the holes and then inserted into the lock holes outside of the battery compartment.

Preferably, the upper side of the battery compartment 7 is provided with a control panel which is integrated with a charging management module connecting an external solar photovoltaic panel.

After the unlocking buttons are pressed relatively at the same time, the side lock rod can be retracted, and then the battery pack can be easily taken out. The control panel is connected with the solar energy input end, so the internal charging management module can convert solar energy into electric energy to charge the battery pack.

Simultaneously, the charging management module can be independently connected with the vehicle power supply or the external power supply for charging the battery pack.

As a preferred embodiment, the front end of the battery pack is provide with a battery switch button which can control the switch of the battery pack independently, and have a power supply and a power indicator light.

As a preferred embodiment, the top of the refrigerator body is provided with a display control module connected with the control panel, and the display control module can display the electric energy and charging of the battery pack.

As a preferred embodiment, the charging management module is connected with the external power supply, the battery pack and the solar photovoltaic panel; the charging management module is also connected with the display control module and a condenser fan.

As a preferred embodiment, the external power supply is DC12V/24V or AC100-240V power supply; when the AC100-240V power supply is used, a power adapter is arranged between the AC100-240V power supply and the charging management module. The bottom of the battery pack is provided with a rectangular built-in charging socket; one side of the battery pack is provided with a circular external charging port, and the charging management module is used to charge the battery pack through the built-in charging socket.

As a preferred embodiment, the display control module is connected with a temperature sensor.

As a preferred embodiment, the display control module is connected with an LED light.

Beneficial effects: The invention relates to a solar rechargeable vehicle refrigerator with plug-in battery and features a simple structure. The battery pack can be easily taken out and fixed in place, and many power supply modes can be used at the same time, thus realizing solar power supply and greatly increasing the power supply modes for the vehicle refrigerator. Therefore, the invention can be used in more scenarios conveniently.

### BRIEF DESCRIPTION OF THE DRAWINGS

FIG. 1 is a structural stereogram of the invention;

FIG. 2 is a lateral and semi-sectional diagram of the invention;

FIG. 3 is an internal structural stereogram of the battery pack of the invention;

FIG. 4 is a structural stereogram of the battery pack installed in the battery compartment of the invention;

FIG. 5 is an exploded view of the battery pack and the battery compartment of the invention;

FIG. 6 is a structural stereogram of the battery pack of the invention;

FIG. 7 is a connection diagram of the control module of the invention.

### DETAILED DESCRIPTION OF THE PREFERRED EMBODIMENT

The invention will be further described in combination with embodiments. It should be understood that these embodiments are only used for easy understanding of the invention, but not used for limiting the scope of the invention. In addition, those skilled in the art can make various changes and modifications after reading the contents of the invention, and these equivalent forms also fall within the scope defined by the claims set forth in this application.

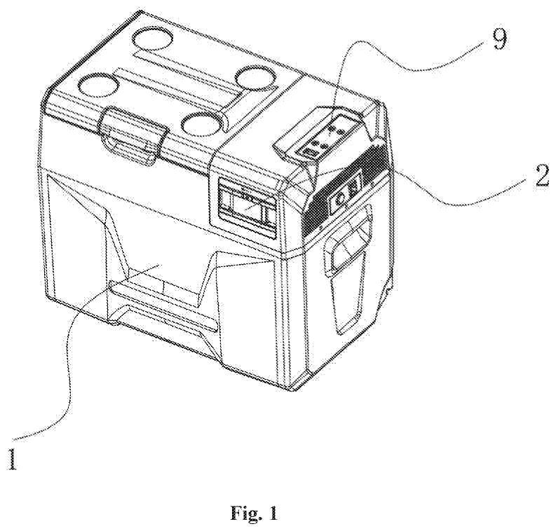

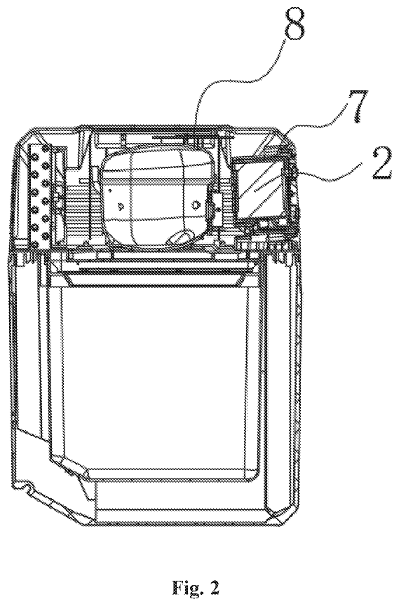

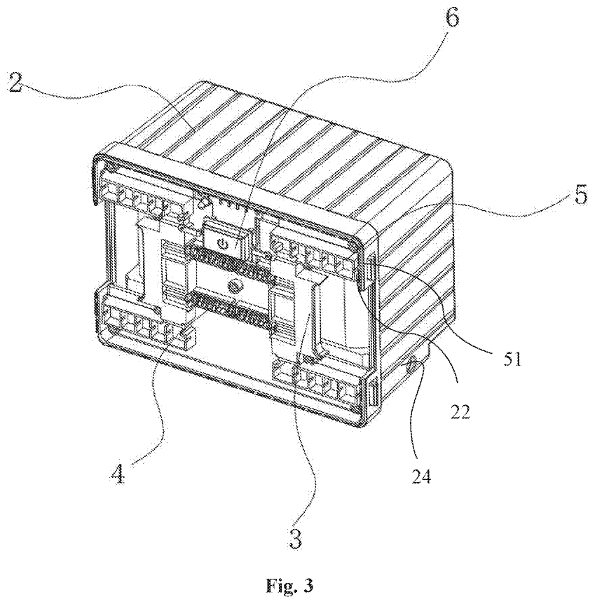

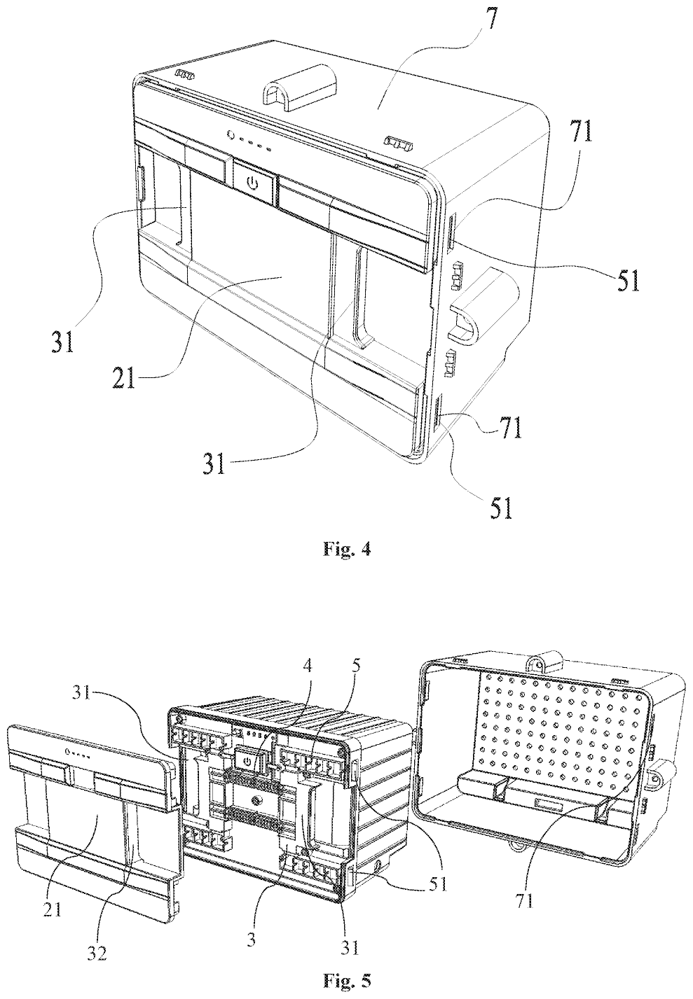

As shown in FIG. 1-FIG. 6, the embodiments of the invention relate to a solar rechargeable vehicle refrigerator with plug-in battery, comprising a refrigerator body 1. One side of the refrigerator body 1 is provided with a battery compartment 7 and a battery pack 2 is inserted into the battery compartment 7; the front end of the battery pack 2 is centrally and symmetrically provided with a pair of unlocking buttons 3 which can relatively and transversely move, and a spring 4 is connected between two unlocking buttons 3 which are correspondingly connected with side lock rods 5, the outer ends 51 of the side lock rods 5 are inserted into the lock holes 71 on sides of the battery compartment 7. In the preferred embodiments of the invention, as shown in FIG. 3 and FIG. 5, each unlocking button 3 is preferably connected with a upper side lock rod and a lower side lock rods 5, and the side of the battery compartment 7 is correspondingly provided with an upper lock hole 71 and a lower lock hole 71.

In the preferred embodiments of the invention, as shown in FIG. 5, the front end of the battery pack 2 is provided with a front cover 21 which can package the unlocking buttons 3, the spring 4 and the side lock rods 5 on the front end of the battery pack. Normally, the front cover 21 and the battery pack 2 are integrated. In order to clearly display the structure of the invention, the front cover 21 should be disassembled (FIG. 5) for description; preferably, through grooves 32 through which the ends of the unlocking buttons 3 can penetrate are arranged on the front cover 21; when the battery pack 2 is inserted into the battery compartment 7, and two unlocking buttons 3 are pressed to retract the side lock rods 5; after the battery pack 2 is completely placed into the battery compartment, the unlocking buttons 3 are released, the outer ends 51 of the side lock rods 5 are driven by the unlocking buttons 3 and the spring 4 to bounce into the lock holes 71 on sides of the battery compartment 7, finally, the battery pack 2 is installed. Preferably, the sides of the front end of the battery pack 2 are also provided with holes 22 corresponding to the side lock rods 5, the outer ends 51 of the side lock rods 5 are inserted into the holes 22 and then inserted into the lock holes 71 outside of the battery compartment 7.

When the battery pack 2 needs to be taken out, the unlocking buttons 3 are pressed relatively at the same time; when the two unlocking buttons 3 move towards each other, the two side lock rods 5 are driven to retract, and then the side lock rods 5 are separated from the lock holes 71 on the battery pack 2, so that the battery pack 2 can be easily taken out.

In the preferred embodiments of the invention, as shown in FIG. 1, the upper side of the battery compartment 7 is provided with a control panel 8 which is integrated with a charging management module connecting an external solar photovoltaic panel. Wherein the control panel 8 is connected with the input end of the solar panel and the internal charging management module can convert solar energy into electric energy to charge the battery pack 2.

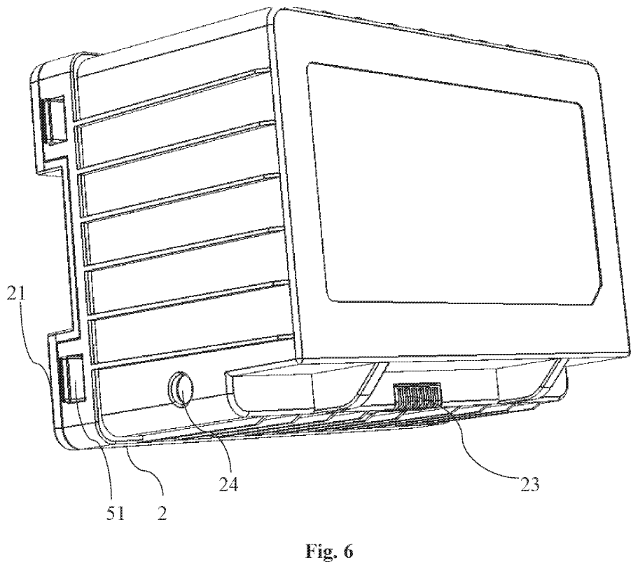

In the preferred embodiments of the invention, the battery pack 2 can be charged by many ways. As shown in FIG. 3 and FIG. 6, the bottom of the battery pack 2 is provided with a rectangular built-in charging socket 23, which can be integrally charged with the vehicle refrigerator or independently coupled with a charger for charging after the battery pack is taken off. In addition, one side of the battery pack 2 is also provided with a circular external charging port 24, and the battery pack 2 can be independently charged through the circular external charging port 24 after being taken out from the battery compartment. Simultaneously, the charging management module can be independently connected with the vehicle power supply or the external power supply for charging the battery pack 2 through the built-in charging socket 23.

The front end of the battery pack 2 is provided with a battery switch button 6 which can control the battery pack independently.

The top of the refrigerator body 1 is provided with a display control module 9 connected with the control panel 8, and the display control module 9 can display the electric energy and charging of the battery pack 2.

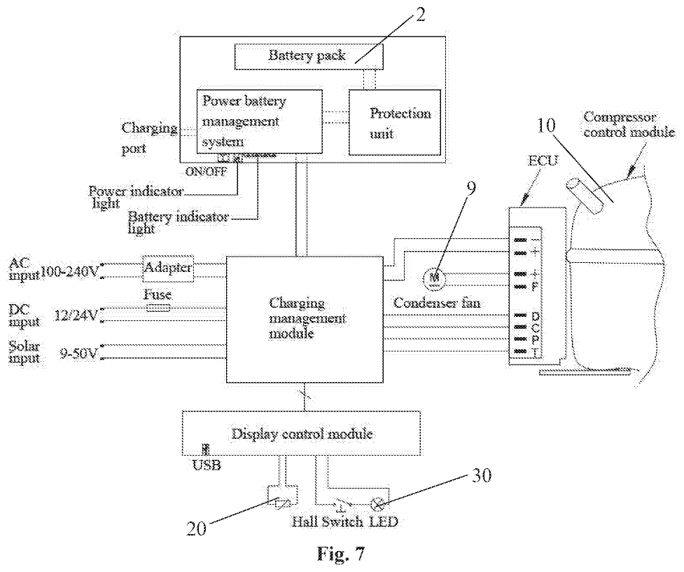

As shown in FIG. 7, in the technical scheme of the invention, the vehicle refrigerator has a multi-power supply input system, the power input system comprises a charging management module and a compressor control module 10; the charging management module can be connected with the external power supply, the vehicle power supply or the solar photovoltaic panel for charging the battery pack 2, and also can be connected with the display control module 9 and the compressor control module 10; the compressor control module 10 is connected with the display control module 9 and a condenser fan. The solar panel is a solar photovoltaic panel and the display control module 9 can be an operating display panel.

In the preferred embodiments of the invention, the external power supply comprises a DC12V/24V power supply and an AC100-240V power supply; when the AC100-240V power supply is used, a power adapter is arranged between the AC100-240V power supply and the charging management module, so that DC power supply or AC power supply can be used to supply power to the battery pack 2.

Simultaneously, the solar photovoltaic panel can convert solar energy into electric energy and charge the battery pack 2 through the charging management module, and can supply power to the vehicle refrigerator. The operating display panel can display information such as the power supply mode and the remaining electric energy of the battery pack. The operating display panel is also connected with a temperature sensor 20 and can display temperature information.

The operating display panel is also connected with an LED light 30.

The invention has a simple structure. The battery pack can be easily taken out and fixed in place, and charged through various sockets. Moreover, solar energy can be converted into power supply through the solar panel to charge the battery pack 2. Many power supply modes can be used at the same time, thus greatly increasing the power supply modes for the vehicle refrigerator. The invention can be used in more scenarios conveniently.

The embodiments of the present invention have been described in detail above with reference to the accompanying drawings, but the present invention is not limited to the described embodiments. For a person skilled in the art, various changes, modifications, substitutions and variations made to these embodiments still fall within the protection scope of the present invention without departing from the principles and spirit of the present invention.

1. A solar rechargeable vehicle refrigerator with plug-in battery, comprising a refrigerator body (1); wherein one side of the refrigerator body (1) being provided with a battery compartment (7) and a battery pack (2) being inserted into the battery compartment (7); the front end of the battery pack (2) being centrally and symmetrically provided with a pair of unlocking buttons (3) which can relatively and transversely move, and a spring (4) being connected between two unlocking buttons (3) which are correspondingly connected with side lock rods (5), the outer ends (51) of the side lock rods (5) being inserted into the lock holes (71) on sides of the battery compartment (7); when the two unlocking buttons (3) being pressed to move towards each other and respectively drive the corresponding side lock rods (5) to move inwards, the outer ends of the side lock rods (5) being separated from the lock holes (71) of the battery compartment.

2. The solar rechargeable vehicle refrigerator with plug-in battery according to claim 1, wherein the front end of the battery pack (2) is provided with a front cover (21) which can be used to package the unlocking buttons (3), the spring (4) and the side lock rods (5) on the front end of the battery pack (2); the front cover (21) is provided with through grooves (32) through which ends (31) of the unlocking buttons (3) can penetrate.

3. The solar rechargeable vehicle refrigerator with plug-in battery according to claim 2, wherein the sides of the front end of the battery pack (2) are also provided with holes (22) corresponding to the outer ends (51) of the side lock rods (5); the outer ends (51) of the side lock rods (5) are inserted into the holes (22) and then inserted into the lock holes (71) outside of the battery compartment (7).

4. The solar rechargeable vehicle refrigerator with plug-in battery according to claim 1, wherein the upper side of the battery compartment (7) is equipped with a control panel (8), and the control panel (8) is integrated with a charging management module which is externally connected with a solar photovoltaic panel.

5. The solar rechargeable vehicle refrigerator with plug-in battery according to claim 4, wherein the front end of the battery pack (2) is provided with a battery switch button (6) having a power supply and a power indicator light; the bottom of the battery pack (2) is provided with a rectangular built-in charging socket (23); one side of the battery pack is provided with a circular external charging port (24), and the charging management module is used to charge the battery pack through the built-in charging socket (23).

6. The solar rechargeable vehicle refrigerator with plug-in battery according to claim 4, wherein the top of the refrigerator body (1) is provided with a display control module (9) connected with the control panel (8).

7. The solar rechargeable vehicle refrigerator with plug-in battery according to claim 6, wherein the charging management module is connected with an external power supply, a battery pack (2) and the solar photovoltaic panel, and also connected with the display control module (9) and a compressor control module (10); the compressor control module (10) is connected with the display control module (9) and a condenser fan.

8. The solar rechargeable vehicle refrigerator with plug-in battery according to claim 7, wherein the external power supply is DC12V/24V or AC100-240V power supply; when the AC100-240V power supply is used, a power adapter is arranged between the AC100-240V power supply and the charging management module.

9. The solar rechargeable vehicle refrigerator with plug-in battery according to claim 7, wherein the display control module (9) is connected with a temperature sensor (20).

10. The solar rechargeable vehicle refrigerator with plug-in battery according to claim 7, wherein the display control module (9) is connected with an LED light (30).
